(19) United States
(12) Patent Application Publication
(10) Pub. No.: US 2010/0208567 A1
(43) Pub. Date: Aug. 19, 2010

(54) Objective Lens and Optical Pickup Apparatus

(76) Inventors: Kentarou Nakamura, Tokyo (JP); Tohru Kimura, Tokyo (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/680,192

(22) PCT Filed: Oct. 2, 2008
(86) PCT No.: PCT/JP2008/067919

§ 371 Date: Mar. 25, 2010

(30) Foreign Application Priority Data
Oct. 30, 2007 (JP) 2007-281457

(51) Int. Cl. G11B 7/135

(52) U.S. Cl. 369/112.03; G9B/7.112

(57) ABSTRACT

An objective lens for an optical pickup apparatus is disclosed that can record and/or reproduce information compatibly for different optical discs with stability regardless of an environmental temperature change, in spite of its simple structure, and provides an optical pickup apparatus employing the objective lens. The objective lens includes: an optical surface which at least includes a central area, a peripheral area, and a most peripheral area. The objective lens is a single lens formed of plastic. The central area includes a first optical path difference providing structure. The peripheral area includes a second optical path difference providing structure. The objective lens further includes an optical path difference providing structure for correcting a temperature characteristic, where the optical path difference providing structure corrects an aberration caused by a temperature change of the objective lens.

### TECHNICAL FIELD

The present invention relates to an objective lens for an optical pickup apparatus which compatibly records and/or reproduces (which may be described as “records/reproduces” in the present invention) information for different types of optical discs, and further relates to an optical pickup apparatus employing the objective lens.

### BACKGROUND ART

In recent years, a wavelength of a laser light source used as a light source for reproducing information which has been recorded in an optical disc and for recording information on an optical disc, is becoming short. For example, laser light sources with 400-420 nm wavelength, such as a blue-violet semiconductor laser and a blue-SHG laser which converts a wavelength of an infrared semiconductor laser utilizing a nonlinear optical effect, are reaching the stage of practical application. By using these blue-violet light sources, information of 15-20 GB can be recorded on an optical disc with a diameter of 12 cm under the condition that an objective lens has the same numerical aperture (NA) as that of DVD (Digital Versatile Disc), and information of 23-25 GB can be recorded onto an optical disc with a diameter of 12 cm under the condition that NA of an objective lens is increased up to 0.85. In this specification, “a high density optical disc” is a general term for optical discs and optical-magnetic discs for which the blue-violet laser light sources are used.

A high density optical disc using an objective lens with NA of 0.85, generates increased comma which is caused by a tilt (skew) of the disc. Therefore, some of the high density optical discs has been designed so that a protective layer has thinner thickness (which is 0.1 mm, while that of DVD is 0.6 mm) than that of DVD, to reduce the amount of comma caused by the skew. On the other hand, it is considered that an optical disc player/recorder (optical information recording reproducing apparatus) is worthless as a product when the optical disc player/recorder is capable of recording/reproducing information just for this type of optical discs properly. Taking account of a fact that, at present, DVDs and CDs (Compact Discs) storing various kinds of information have been on the market, it is not sufficient that the optical disc player/recorder can records/reproduces information just for high density optical discs, and an attempt providing an optical disc player/recorder capable to record/reproduce information also for DVD and CD which have already been owned by users, leads to enhancement of a commercial value of the optical disc player/recorder for high density optical discs. From such the background, an optical pickup apparatus installed in the high-density optical disc player/recorder is required to be capable of appropriately recording/reproducing information not only for a high-density optical disc but also for a DVD and a CD.

As a method by which information can be adequately recorded/reproduced while the compatibility is maintained to anyone of the high density optical disc and DVD and further to CD, there can be considered a method to selectively switch an optical system for the high density optical disc and an optical system for DVD and CD, corresponding to a recording density of an optical disc on which information is recorded/reproduced. However, it is disadvantageous for the size-reduction and increases a cost, because plural of optical systems are needed.

Accordingly, in order to simplify a structure of the optical pickup apparatus and to intend a reduction of its cost, it is preferable to form the optical system for the high density optical disc and the optical system for DVD and CD into a common optical system, and to reduce the number of optical parts forming the optical pickup apparatus as much as possible, even in the optical pickup apparatus with compatibility. Then, providing the common objective lens which is arranged with facing an optical disc, is most advantageous for the simplification of the structure and for cost reduction of the optical pickup apparatus. In order to obtain a common objective lens for plural kinds of optical discs which use different wavelengths for recording/reproducing information, it is required that an optical path difference providing structure having a wavelength dependency for the spherical aberration, is formed in the objective optical system.

Patent Literature 1 has disclosed an objective optical system which includes a diffractive structure as an optical path difference providing structure and can be commonly used for the high density optical disc and the conventional DVD and CD, and also has disclosed an optical pickup apparatus in which this objective optical system is mounted.

Patent Literature: JP-A No. 2005-158217

### DISCLOSURE OF INVENTION

### Technical Problem

In Patent Literature 1, information is compatibly recorded/reproduced for three different types of optical discs, by using a diffractive optical element including a first diffractive surface which does not diffract a light beam with a first wavelength λ1 and a light beam with a third wavelength λ3 and diffracts a light beam with a second wavelength λ2, and further including a second diffractive surface which does not diffract a light beam with the first wavelength λ1 and a light beam with the second wavelength λ2 and diffracts a light beam with a light beam with the third wavelength λ3. However, according to the technology of Patent Literature 1, the objective optical system is formed by two optical elements, thereby, it requires highly accurate assembly and results in a higher cost, which is a problem.

In contrast to the aforesaid technology, there has been developed a technology to compatibly record/reproduce information for three different types of optical discs by using an objective lens that is a single lens. As an example, there has been a technology to provide an optical path difference providing structure, for example, on the single-element objective lens, and the optical path difference providing structure generates +first order diffracted light when a blue-violet laser light flux enters therein, generates −first order diffracted light when a red laser light flux enters therein, and generates −second order diffracted light when an infrared light flux enters therein, to form a proper converged spot on an information recording surface of each of the high density optical disc, DVD, and CD. This embodiment is easily produced and preferable in the way that optical path difference providing structures are not required to be overlapped with each other in order to achieve the compatibility.

When single-element objective lenses are manufactured by injection molding with plastics, mass production is possible and dramatic cost reduction can be realized accordingly. However, a general plastic exhibits a relatively large change in refractive index corresponding to a temperature change, which causes a problem that optical properties tend to be deteriorated in a plastic objective lens. In particular, under a condition that the aforesaid optical path difference providing structure is formed thereon, when the property of a semiconductor laser has been changed corresponding to a temperature change and a wavelength of an emitted light flux has been changed to the plus (+) side, spherical aberration can change to the plus (+) side (the “over” side) and the optical property can be worsen.

The present invention has been achieved in view of the aforesaid problems in the prior art, and one of its objects is to provide an objective lens for an optical pickup apparatus capable of compatibly recording/reproduction information for different optical discs with stability regardless of an environmental temperature change, in spite of its simple and inexpensive structure such that the number of overlapped optical path difference providing structures is controlled to the minimum, and to provide an optical pickup apparatus that employs the aforesaid objective lens.

### Solution to Problem

An objective lens of Claim 1 is an objective lens for use in an optical pickup apparatus, and for forming a converged spot on an information recording surface of a first optical disc including a protective layer with a thickness t1 by using a first light flux with a wavelength λ1 emitted from a first light source, forming a converged spot on an information recording surface of a second optical disc including a protective layer with a thickness t2 (t1≦t2) by using a second light flux with a wavelength λ2 (λ1<λ2) emitted from a second light source, and forming a converged spot on an information recording surface of a third optical disc including a protective layer with a thickness t3 (t2<t3) by using a third light flux with a wavelength λ3 (λ2<λ3). The objective lens is a single lens formed of plastic, and the objective lens comprises: an optical surface which at least includes a central area including an optical axis, a peripheral area formed in a ring shape around the central area, and a most peripheral area formed in a ring shape around the peripheral area. The objective lens converges the first light flux passing through the central area, the peripheral area, and the most peripheral area onto the information recording surface of the first optical disc. The objective lens converges the second light flux passing through the central area and the peripheral area onto the information recording surface of the second optical disc. The objective lens converges the third light flux passing through the central area onto the information recording surface of the third optical disc. The central area includes a first optical path difference providing structure and the objective lens satisfies any one of the following combinations: (M, N, O)=(+1, −1, −2), (+1, −2, −3), and (+1, −1, −1), where M is a diffraction order of a diffracted light flux with a maximum diffracted light amount among diffracted light fluxes generated when the first light flux enters the first optical path difference providing structure, N is a diffraction order of a diffracted light flux with a maximum diffracted light amount among diffracted light fluxes generated when the second light flux enters the first optical path difference providing structure, and O is a diffraction order of a diffracted light flux with a maximum diffracted light amount among diffracted light fluxes generated when the third light flux enters the first optical path difference providing structure. The peripheral area includes a second optical path difference providing structure. The objective lens further comprises an optical path difference providing structure for correcting a temperature characteristic, where the optical path difference providing structure corrects an aberration caused by a temperature change of the objective lens.

According to the present invention, the central area employs the first optical path difference providing structure, thereby, there has been no need to overlap optical path difference providing structures for compatibility with each other. Further, by employing the optical path difference providing structure for correcting a temperature characteristic, it is allowed that information is recorded and reproduced compatibly for different three types of optical discs with stability in an environment temperature change, despite of its simple structure.

In an objective lens of Claim 2, according to the invention described in Claim 1, the objective lens satisfies P≠Q, where P is a diffraction order of a diffracted light flux with a maximum diffracted light amount among diffracted light fluxes generated when the first light flux enters the second optical path difference providing structure, and Q is a diffraction order of a diffracted light flux with a maximum diffracted light amount among diffracted light fluxes generated when the second light flux enters the second optical path difference providing structure.

In an objective lens of Claim 3, according to the invention described in Claim 1 or 2, the optical path difference providing structure for correcting a temperature characteristic, is a third optical path difference providing structure formed to be overlapped with the first optical path difference providing structure in the central area, or a fourth optical path difference providing structure formed to be overlapped with the second optical path difference providing structure in the peripheral area.

In an objective lens of Claim 4, according to the invention described in Claim 3, the objective lens satisfies R=+10, S=+6, and T=+5, where R is a diffraction order of a diffracted light flux with a maximum diffracted light amount among diffracted light fluxes generated when the first light flux enters the third optical path difference providing structure, S is a diffraction order of a diffracted light flux with a maximum diffracted light amount among diffracted light fluxes generated when the second light flux enters the third optical path difference providing structure, and T is a diffraction order of a diffracted light flux with a maximum diffracted light amount among diffracted light fluxes generated when the third light flux enters the third optical path difference providing structure.

In an objective lens of Claim 5, according to the invention described in Claim 3, the objective lens satisfies R=+2, S=+1, and T=+1, where R is a diffraction order of a diffracted light flux with a maximum diffracted light amount among diffracted light fluxes generated when the first light flux enters the third optical path difference providing structure, S is a diffraction order of a diffracted light flux with a maximum diffracted light amount among diffracted light fluxes generated when the second light flux enters the third optical path difference providing structure, and T is a diffraction order of a diffracted light flux with a maximum diffracted light amount among diffracted light fluxes generated when the third light flux enters the third optical path difference providing structure.

In an objective lens of Claim 6, according to the invention described in any one of Claims 3 to 5, the objective lens satisfies V=+10 and W=+6, where V is a diffraction order of a diffracted light flux with a maximum diffracted light amount among diffracted light fluxes generated when the first light flux enters the fourth optical path difference providing structure, and W is a diffraction order of a diffracted light flux with a maximum diffracted light amount among diffracted light fluxes generated when the second light flux enters the fourth optical path difference providing structure.

In an objective lens of Claim 7, according to the invention described in any one of Claims 3 to 5, the objective lens satisfies V=+5 and W=+3, where V is a diffraction order of a diffracted light flux with a maximum diffracted light amount among diffracted light fluxes generated when the first light flux enters the fourth optical path difference providing structure, and W is a diffraction order of a diffracted light flux with a maximum diffracted light amount among diffracted light fluxes generated when the second light flux enters the fourth optical path difference providing structure.

In an objective lens of Claim 8, according to the invention descried in any one of Claims 3 to 5, the objective lens satisfies V=+2 and W=+1, where V is a diffraction order of a diffracted light flux with a maximum diffracted light amount among diffracted light fluxes generated when the first light flux enters the fourth optical path difference providing structure, and W is a diffraction order of a diffracted light flux with a maximum diffracted light amount among diffracted light fluxes generated when the second light flux enters the fourth optical path difference providing structure.

In an objective lens of Claim 9, according to the invention descried in any one of Claims 1 to 8, the most peripheral area is formed around the peripheral area and includes a fifth optical path difference providing structure as an optical path difference providing structure for correcting a temperature characteristic, and the objective lens converges the first light flux passing through the most peripheral area onto the information recording surface of the first optical disc.

In an objective lens of Claim 10, according to the invention described in any one of Claims 1 to 9, the optical path difference providing structure for correcting a temperature characteristic, is a fifth optical path difference providing structure formed in the most peripheral area.

An optical pickup apparatus of Claim 11 is an optical pickup apparatus comprising an objective lens of any one of Claims 1 to 10.

An optical pickup apparatus relating to the present invention includes at least a first light source. It may include a second light source additionally to the first light source and may further include a third light source. The optical pickup apparatus relating to the present invention further includes a light-converging optical system for converging a first light flux onto an information recording surface of a first optical disc. When the second light source is employed, the light-convergent optical system converges a second light flux on an information recording surface of a second optical disc. When the third light source is employed, the light-convergent optical system converges a third light flux on an information recording surface of a third optical disc. The optical pickup apparatus relating to the present invention further includes a light-receiving element for receiving a reflection light from the information recording surface of the first optical disc. The optical pickup apparatus may further includes another light-receiving element for receiving a reflection light from the information recording surface of the second optical disc or the third optical disc.

The first optical disc includes a protective substrate with a thickness of t1 and an information recording surface. The second optical disc includes a protective substrate with a thickness of t2 (t1≦t2) and an information recording surface. The third optical disc includes a protective substrate with a thickness of t3 (t2<t3) and an information recording surface. It is preferable that the first optical disc is a high density optical disc, the second optical disc is DVD, and the third optical disc is CD, but optical discs are not limited to those. Each of the first optical disc, the second optical disc, and the third optical disc may be a multilayer optical disc with a plurality of information recording surfaces.

As an example of a high density optical disc in the present specification, there is cited an optical disc (for example, BD: Blue-ray Disc) based on the standard that information is recorded/reproduced by an objective lens with NA 0.85, and that a protective substrate of the optical disc is about 0.1 mm. Further, as an example of another high density optical disc, there is cited an optical disc (for example, HD DVD: it also called HD) based on the standard that information is recorded/reproduced by an objective lens with NA in the range of 0.65 to 0.67 and a protective substrate of the optical disc is about 0.6 mm. Further, high density optical discs include an optical disc having a protective film (in the present specification, a protective substrate includes also a protective film), having a thickness of about several to several ten nm on its information recording surface, or an optical disc whose protective substrate thickness is 0 (zero). High density optical discs further include a photo-magnetic disc for which a blue-violet semiconductor laser or blue-violet SHG laser is used as a light source for recording/reproducing information. Further, DVD in the present specification represents a generic name of optical discs based on the standard that information is recorded/reproduced by an objective lens with NA in the range of 0.60 to 0.67 and that the protective substrate of the optical disc is about 0.6 mm, which belong to DVD group such as DVD-ROM, DVD-Video, DVD-Audio, DVD-RAM, DVD-R, DVD-RW, DVD+R and DVD+RW. In the present specification, CD represents a generic name of optical discs based on the standard that information is recorded and/or reproduced by an objective lens with NA in the range of 0.45 to 0.51 and that the protective substrate of the optical disc is about 1.2 mm, which belong to CD group such as CD-ROM, CD-Audio, CD-Video, CD-R and CD-RW. Among these optical discs, a high density optical disc provides the highest recording density. DVD and CD provide the second highest recording density, the third highest recording density, respectively.

Thicknesses t1, t2, and t3 of the protective substrates preferably satisfy the following conditional expressions (1), (2), and (3), but the thicknesses are not limited to those.

0.0750 mm≦t1≦0.125 mm or 0.5 mm≦t1≦0.7 mm (1)

0.5 mm≦t2≦0.7 mm (2)

1.0 mm≦t3≦1.3 mm (3)

In the present specification, each of the first light source, the second light source, and the third light source is preferably a laser light source. A semiconductor laser, and a silicon laser are preferably used for the laser light source. First wavelength λ1 of a first light flux emitted from the first light source, second wavelength λ2 (λ2>λ1) of a second light flux emitted from the second light source, third wavelength λ3 (λ3>λ2) of a third light flux emitted from the third light source, are preferable to satisfy the following conditional expressions (4) and (5).

1.5×λ1<×2<1.7×λ1 (4)

1.9×λ1<λ3<2.1×λ1 (5)

When BD or HD is employed as the first optical disc, the wavelength λ1 of the first light source is preferably 390 nm or more, and 420 nm or less. When DVD is employed as the second optical disc, the second wavelength λ2 of the second light source is preferably 570 nm or more, and 680 nm or less. The second wavelength λ2 is more preferably 630 nm or more, and 670 nm or less. When CD is employed for the third optical disc, the third wavelength λ3 of the third light source is preferably 750 nm or more, and 880 nm or less. The third wavelength λ3 is more preferably 760 nm or more, and 820 nm or less.

Further, at least two light sources of the first light source, the second light source, and the third light source may also be unitized. The unitization means fixing and housing, for example, the first light source and the second light source into one package.

As the light-receiving element, a photodetector such as a photodiode is preferably used. Light reflected on an information recording surface of an optical disc enters the light-receiving element, and signal outputted from the light-receiving element is used for obtaining the read signal of the information recorded in each optical disc. Further, change in the light amount of the spot on the light-receiving element caused with the change in the spot shape and the change in the spot position, is detected to conduct the focus detection and the tracking detection. The objective lens can be moved based on these detections for focusing and tracking of the objective lens. The light-receiving element may be composed of a plurality of photodetectors. The light-receiving element may also have a main photodetector and secondary photodetector. For example, the light-receiving element can be provided with a main photodetector which receives a main light used for recording and reproducing information, and with two secondary photodetectors positioned on both sides of the main photodetector so as to receive secondary light for tracking adjustment by the two secondary photodetectors. Alternatively, the light receiving-element may be provided with a plurality of light-receiving elements corresponding to respective light sources.

The optical pickup apparatus is preferably provided with a monitor means which monitors an intensity of a light flux before a light flux emitted from the light source enters the objective lens. Such the monitor means detects an intensity of the light flux that has emitted from the light source, but does not detect an intensity of the light flux that has passed through the objective lens. Therefore, a fluctuation of diffraction efficiency in an optical path difference providing structure such as a basic structure, is not detected. Accordingly, effects of the present invention become more significant in an optical pickup apparatus including such the monitor means.

The light-converging optical system of the optical pickup apparatus comprises an objective lens. The light-converging optical system may include only an objective lens, however, the light-converging optical system may also have a coupling lens such as a collimation lens other than the objective lens. The coupling lens means a single lens or a lens group which is arranged between the objective lens and the light source and changes divergent angle of a light flux. The collimation lens is a kind of coupling lens and is a lens to convert an incident light flux into a parallel light flux and to output the resulting light flux. The light-converging optical system may further comprise an optical element such as a diffractive optical element which divides a light flux emitted from the light source into a main light flux used for recording reproducing information and two secondary light fluxes used for a tracking operation. In the present specification, an objective lens means an optical system which is arranged to face the optical disc in the optical pickup apparatus and has a function to converge a light flux emitted from the light source onto an information recording surface of the optical disc. Preferably, the objective lens means an optical system which is arranged to face the optical disc in the optical pickup apparatus, has a function to converge a light flux emitted from the light source onto an information recording surface of the optical disc, and is movable as one body along the optical axis by using an actuator. The objective lens may be formed of a plurality of lenses. Alternatively, the objective lens may be a single lens, but the objective lens is preferably formed of a single lens. When the objective lens is formed of a plurality of lenses, the plurality of lenses may be a combination of: a flat-plate optical element including an optical path difference providing structure as a basic structure, and an aspheric lens (which may include no optical path difference providing structure). The objective lens preferably includes a refractive surface which is an aspheric surface. Further, in the objective lens, it is preferable that its base surface where an optical path difference providing structure is provided as a basic structure, is an aspheric surface.

Further, the objective lens is a plastic lens. As a material of the objective lens, it is preferable that a cyclic olefin resins are employed. In the cyclic olefins, there is more preferably used a resin material in which refractive index at the temperature 25° C. for wavelength 405 nm, is within the range of 1.53 to 1.60, and ratio of refractive index change dN/dT (° C.⁻¹) corresponding to a temperature change within the temperature range of −5° C. to 70° C. for the wavelength 405 nm, is within the range of −20×10⁻⁵ to −5×10⁻⁵ (more preferably, −10×10⁻⁵ to −8×10⁻⁵). Further, when a plastic lens is employed for the objective lens, it is preferable that a plastic lens is also employed for the coupling lens.

The objective lens will be described below. At least one optical surface of the objective lens comprises a central area and a peripheral area surrounding the central area. More preferably, at least one optical surface of the objective lens further includes a most peripheral area surrounding the peripheral area. By providing the most peripheral area, it allows to record and/or reproduce information more appropriately for the optical disc using high NA. The central area is preferably an area including the optical axis of the objective lens, however, it may be the area including no optical axis. It is preferable that the central area, peripheral area, and most peripheral area are provided on the same optical surface. It is preferable that the central area, peripheral area, most peripheral area are provided on the same optical surface concentrically around the optical axis. Further, an optical path difference providing structure is provided in each of the central area and the peripheral of the objective lens. When the objective lens includes the most peripheral area, the most peripheral area can be a refractive surface, or an optical path difference providing structure can be formed on the most peripheral area. It is preferable that each of the central area, peripheral area, and most peripheral area adjoins to the neighboring area. Alternatively, however, there may be slight spaces between the neighboring areas.

The optical path difference providing structure used in the present specification, is the general name of a structure which provides an optical path difference to an incident light flux. The optical path difference providing structure also includes a phase difference providing structure which provides a phase difference. Further, the phase difference providing structure includes a diffractive structure. The optical path difference providing structure includes a step, preferably, includes a plurality of steps. The step provides an optical path difference and/or phase difference to an incident light flux. The optical path difference added by the optical path difference providing structure may be an integer times of the wavelength of the incident light flux, or may be non-integer times of the wavelength of the incident light flux. The steps may be arranged with periodic interval in the direction perpendicular to the optical axis, or may be arranged with non-periodic interval in the direction perpendicular to the optical axis.

It is preferable that the optical path difference providing structure includes a plurality of ring-shaped zones in a form of concentric circles whose centers are on the optical axis. It is preferable that each of the ring-shaped zones are divided by a step. Further, it is preferable that the optical path difference providing structure is a structure with a cross section which includes the optical axis and has a shape such that stair-shaped patterns are repeated. Alternatively, the structure may be a structure such that plural optical path difference providing structures are overlapped in the same area. In this case, the phrase “plural optical path difference providing structures are overlapped” means that an optical path difference providing structure which provides a displacement amount obtained by adding respective displacement amounts along the optical axis in the optical path difference providing structures together, is formed on a predetermined area of an optical surface. In the present specification, the overlapped state does not include a state that one basic structure and the other basic stricture are formed on different optical surfaces respectively, and a state that they are formed on different areas respectively without no overlapped portion of the basic structures while they are formed on the same optical surface.

At least a first optical path difference providing structure is formed on the central area of the objective lens, and at least a second optical path difference providing structure is formed on the peripheral area of the objective lens.

When M represents a diffraction order of a diffracted light flux with the maximum diffracted light amount among diffracted light fluxes generated when the first light flux with wavelength λ1 coming from the first light source enters the first optical path difference providing structure of the objective lens, then, when N represents a diffraction order of a diffracted light flux with the maximum diffracted light amount among diffracted light fluxes generated when the second light flux with wavelength λ2 coming from the second light source enters the first optical path difference providing structure, and O represents a diffraction order of a diffracted light flux having the maximum diffracted light amount among diffracted light fluxes generated when the third light flux having wavelength λ3 coming from the third light source enters the first optical path difference providing structure, at least one of M, N and O is positive, and at least one of M, N and O is negative. It is preferable that the first optical path difference providing structure is a structure for compatibility among different optical discs.

Examples of preferable combination of M, N and O are cited below.

(M, N, O)=(+1, −1, −2), (+1, −2, −3), (+1, −1, −1)

When P represents a diffraction order of the diffracted light flux with the maximum diffracted light amount among diffracted light fluxes generated when the first light flux with wavelength λ1 coming from the first light source enters the second optical path difference providing structure of the objective lens, and when Q represents a diffraction order of the diffracted light flux having the maximum diffracted light amount among diffracted light fluxes generated when the second light flux with wavelength λ2 coming from the second light source enters the second optical path difference providing structure, P≠Q is preferable, but P=Q is also allowable. It is preferable that the second optical path difference providing structure is also a structure for compatibility among different optical discs.

In this case, P=M and Q=N may hold.

Examples of preferable combination of P and Q are cited below.

(P, Q)=(+1, −1), (+1, −2), (0, −1)

Incidentally, in the case of (P, Q)=(0, −1), there is no need to separately provide a structure for generating flare for the third optical light flux that will be described later, which is preferable.

Further, the objective lens includes an optical path difference providing structure for correcting a temperature characteristic that corrects aberration caused by a temperature change of the objective lens. “The optical path difference providing structure for correcting a temperature characteristic” means an optical path difference providing structure that corrects aberration caused when a temperature changes, and for example, it is an optical path difference providing structure having a function to make spherical aberration to be “under-correction” when a temperature rises and wavelengths of the first, second and third light sources increase. Due to this, it is possible to compensate “over-corrected” spherical aberration that is caused by a decline of refractive index of plastic in the case of a temperature rise, which makes it possible to obtain excellent spherical aberration. When this optical path difference providing structure for correcting a temperature characteristic is provided by being overlapped with the first optical path difference providing structure in the central area, this optical path difference providing structure is defined as a third optical path difference providing structure. When this optical path difference providing structure for correcting a temperature characteristic is provided by being overlapped with a second optical path difference providing structure in the peripheral area, this optical path difference providing structure is defined as a fourth optical path difference providing structure. Further, when the objective lens includes the most peripheral area as stated later, and when the optical path difference providing structure for correcting a temperature characteristic on the most peripheral area, this optical path difference providing structure is defined as a fifth optical path difference providing structure.

It is defined that R represents a diffraction order of a diffracted light flux with the maximum diffracted light amount among diffracted light fluxes generated when a first light flux enters a third optical path difference providing structure, S represents a diffraction order of a diffracted light flux with the maximum diffracted light amount among diffracted light fluxes generated when a second light flux enters a third optical path difference providing structure, and T represents a diffraction order of a diffracted light flux with the maximum diffracted light amount among diffracted lights generated when a third light flux enters a third optical path difference providing structure. Under these definitions, it is preferable that (R, S, T)=(+10, +6, +5) or (R, S, T)=(2, +1, +1) holds.

It is defined that V represents a diffraction order of a diffracted light flux with the maximum diffracted light amount among diffracted light fluxes generated when a first light flux enters a fourth optical path difference providing structure, and W represents a diffraction order of a diffracted light flux with the maximum diffracted light amount among diffracted light fluxes generated when a second light flux enters the fourth optical path difference providing structure. Under these definitions, it is preferable that (V, W)=(+10, +6), (+5, +3) or (+2, +1) holds.

With respect to a fifth optical path difference providing structure, there is no special limitation for diffraction orders.

The objective lens may include all of the third, fourth and fifth optical path difference providing structures, or it may include only the fourth and fifth optical path difference providing structures. Alternatively, it may include only the fifth optical path difference providing structure. Namely, there can be provided an embodiment that only the most peripheral area includes an optical path difference providing structure for correcting a temperature characteristic. In particular, when only the fifth optical path difference providing structures is included, complicated structure can be avoided, thus, manufacturing becomes easy and a loss of light amount can be reduced, which is preferable.

Although both of the optical path difference providing structure to be provided on the central area of the objective lens and the optical path difference providing structure to be provided on the peripheral area of the objective lens can be provided respectively on different optical surfaces, it is preferable that both of them is provided on the same optical surface of the objective lens. When they are provided on the same optical surface, a decentration error in the course of manufacturing can be reduced, which is preferable. An optical path difference providing structure is provided more preferably on the surface on the light-source side in the objective lens than on the surface on the optical-disc side in the objective lens.

Now, an example of a principle for correcting spherical aberration caused by a temperature change with a third optical path difference providing structure will be explained. Line (A) in FIG. 3 indicates how a wavefront behaves when a temperature rises from the design reference temperature on a single lens as an example which has two optical surfaces each being an aspheric surface and is made of plastic, where the lateral axis represents an effective radius of the optical surface and the longitudinal axis represents an optical path difference. In the single lens, spherical aberration is caused owing to a refractive index change resulted from a temperature change, and the wavefront changes as is shown by line (A). When the single lens is made of a plastic material, in particular, a refractive index change caused by a temperature change is great, thus, a generation amount of spherical aberration grows greater.

Line (B) represents an optical path difference to be added to a transmitted wavefront by an overlapped structure in which the first optical path difference providing structure and the third optical path difference providing structure are overlapped with each other, and line (C) represents a diagram showing how the wavefront having passed through the overlapped structure and the single lens behaves when a temperature rises from the design reference temperature. As can be seen from the line (B) and the line (C), when a wavefront that has passed through the overlapped structure and a wavefront on the single lens under the condition that temperature rises from the design reference temperature, cancel each other, a wavefront of a laser beam converged on an information recording surface of an optical disc becomes a wavefront that looks excellent without optical path difference when it is viewed macroscopically, and is corrected in terms of temperature aberration by the third optical path difference providing structure. Incidentally, the same actions as those in the foregoing are generated also in the fourth optical path difference providing structure or in the fifth optical path difference providing structure.

The objective lens may include an optical path difference providing structure for generating flare for the third optical light flux, arranged on the peripheral area. With respect to the optical path difference providing structure for generating flare, the followings are preferably satisfied: A=0, B=0 and C=±1, where A represents a diffraction order of a diffracted light flux with the maximum diffracted light amount among diffracted light fluxes generated when the first light flux with wavelength λ1 coming from the first light source enters the optical path difference providing structure, B represents a diffraction order of a diffracted light flux with the maximum diffracted light amount among diffracted light fluxes generated when the second light flux with wavelength λ2 coming from the second light source enters the optical path difference providing structure, and C represents a diffraction order of a diffracted light flux with the maximum diffracted light amount among diffracted light fluxes generated when the third light flux with wavelength λ3 coming from the third light source enters the optical path difference providing structure. The third light flux that has passed through the optical difference providing structure for generating flare is not converged on an information recording surface of the third optical disc.

The objective lens converges each of the first light flux, second light flux and third light flux passing through the central area of the objective lens, so as to form a converged spot. When thickness t1 of the protective substrate of the first optical disc is different from thickness t2 of the protective substrate of the second optical disc, it is preferable that the first optical path difference providing structure corrects spherical aberration generated by a difference between thickness t1 of the protective substrate of the first optical disc and thickness t2 of the protective substrate of the second optical disc, and/or spherical aberration generated by a difference between the wavelength of the first light flux and the wavelength of the second light flux, for the first light flux and the second light flux which have passed through the first optical path difference providing structure. It is further preferable that the first optical path difference providing structure corrects spherical aberration generated by a difference between thickness t1 of the protective substrate of the first optical disc and thickness t3 of the protective substrate of the third optical disc, and/or spherical aberration generated by a difference between the wavelength of the first light flux and the wavelength of the third light flux, for the first light flux and the third light flux which have passed through the first optical path difference providing structure.

Further, the objective lens converges each of the first light flux and the second light flux passing through the peripheral area of the objective lens, so as to form a converged spot. Further, when thickness t1 of the protective substrate of the first optical disc is different from thickness t2 of the protective substrate of the second optical disc, it is preferable that the second optical path difference providing structure corrects spherical aberration generated by a difference between thickness t1 of the protective substrate of the first optical disc and thickness t2 of the protective substrate of the second optical disc, and/or spherical aberration generated by a difference between the wavelength of the first light flux and the wavelength of the second light flux, for the first light flux and the second light flux which have passed through the second optical path difference providing structure.

Further, as a preferred embodiment, there is given an embodiment such that the third light flux which has passed through the peripheral area including the optical path difference providing structure for generating flare is not used for recording and/or reproduction information for the third optical disc. It is preferable that the third light flux that has passed through the peripheral area does not contribute to formation of a converged spot on the information recording surface of the third optical disc. In other words, it is preferable that the third light flux passing through the peripheral area of the objective lens forms flare on the information recording surface of the third optical disc. In the spot formed out of the third light flux that has passed through the objective lens, on the information recording surface of the third optical disc, there are provided a central spot portion with a high light density, an intermediate spot portion with a light density that is lower than that of the central spot portion, and a peripheral spot portion with a light density that is higher than that of the intermediate spot portion and is lower than that of the central spot portion, in the order in the direction from the optical axis side (or the central spot portion) to the outer side. The central spot portion is used for recording and/or reproduction information for an optical disc, and the intermediate spot portion and the peripheral spot portion are not used for recording and/or reproduction information for an optical disc. In the foregoing, this peripheral spot portion is called flare. In other words, the third light flux that has passed through the peripheral area of the objective lens forms a peripheral spot portion on the information recording surface of the third optical disc. As for the second light flux that has passed through the objective lens, it is preferable that the spot formed on the information recording surface of the second optical disc also has a central spot portion, an intermediate spot portion and a peripheral spot portion.

There can be provided an optical path difference providing structure such that the third light flux that has passed through a peripheral area does not form flare on the information recording surface of the third optical disc. In this case, it is preferable to employ a dichroic filter for performing an aperture limitation.

When the objective lens has the most peripheral area, the objective lens converges the first light flux which has passed through the most peripheral area of the objective lens, so as to be capable of recording and/or reproducing information on an information recording surface of the first optical disc. It is preferable that, in the first light flux which has passed through the most peripheral area, its spherical aberration is preferably corrected when information is recorded and/or reproduced for the first optical disc.

Further, as a preferred embodiment, there is given an embodiment wherein the second light flux which has passed through the most peripheral area is not used for recording and/or reproduction for the second optical disc, and the third light flux which has passed through the most peripheral area is not used for recording and/or reproduction for the third optical disc. It is preferable that each of the second and the third light fluxes that have passed through the most peripheral area does not contribute to formation of a converged spot on each of the information recording surfaces of the second and the third optical discs. In other words, when the objective lens includes the most peripheral area, it is preferable that the third light flux that passes through the most peripheral area of the objective lens forms flare on the information recording surface of the third optical disc. In other words, it is preferable that the third light flux having passed the most peripheral area of the objective lens forms a peripheral spot portion on the information recording surface of the third optical disc. Further, when the objective lens includes the most peripheral area, it is preferable that the second light flux passing through the most peripheral area of the objective lens forms flare on the information recording area of the second optical disc. In other words, it is preferable that the second light flux having passed through the most peripheral area of the objective lens forms a peripheral spot portion on the information recording surface of the second optical disc.

As a preferred embodiment, there is given an embodiment wherein the third optical path difference providing structure for correcting aberration caused by a temperature change of the objective lens is overlapped with the first optical path difference providing structure in the central area, the fourth optical path difference providing structure for correcting aberration caused by a temperature change of the objective lens is overlapped with the second optical path difference providing structure in the peripheral area, and the fifth optical path difference providing structure for correcting aberration caused by a temperature change of the objective lens is provided on the most peripheral area. As an another preferred embodiment, there is given an embodiment wherein only the first optical path difference providing structure is provided in the central area, only the second optical path difference providing structure is provided in the peripheral area, and the fifth optical path difference providing structure for correcting aberration caused by a temperature change of the objective lens is provided in the most peripheral area.

It is also possible to employ an embodiment wherein each of the second light flux and the third light flux which have passed through the most peripheral area does not form flare on the information recording surface of each of the second optical disc and the third optical disc. In this case, it is preferable to use a dichroic filter for performing an aperture limitation.

Further, when designing an optical element relating to the present invention, there is a possibility that a ring-shaped zone having a small pitch width is generated. Incidentally, the pitch width means a width of a ring-shaped zone structure in the direction perpendicular to the optical axis of the optical element with the optical path difference providing structure.

After earnest studies, the inventors of the present invention found out that optical performances are not greatly affected even when a ring-shaped zone is shaved off or is filled up, if the pitch width of the ring-shaped zone is less than 5 μm. In other words, when the pitch width is less than 5 μm, optical performances are not affected greatly even when the ring-shaped zone with a small pitch width is shaved off.

From the viewpoint of easy manufacturing of a mold and of excellent transferability of a mold, it is preferable that the pitch width of a step is not too small. Therefore, if ring-shaped zone whose pitch width is less than 5 μm is generated when an optical path difference providing structure is designed, it is preferable to obtain the final optical path difference providing structure by removing such the ring-shaped zone with a pitch width of less than 5 μm. When the ring-shaped zone whose pitch width is less than 5 μm is in a convex shape, the convex shape can be removed by shaving off the ring-shaped zone. While, when the ring-shaped zone whose pitch width is less than 5 μm is in a concave shape, the concave shape can be removed by filling up the ring-shaped zone.

Therefore, it is preferable that all of the pitch widths of the optical path difference providing structure are 5 μl or more.

From a viewpoint that the value of (“step amount”/“pitch width”) is preferably small for manufacturing, the entire of the ring shaped zones of the optical path difference providing structure satisfies that the value of (“step amount”/“pitch width”) is preferably 1 or less, and more preferably is 0.8 or less. Further more preferably, the entire of the ring shaped zones of all of the optical path difference providing structures satisfy that the value of (“step amount”/“pitch width”) is preferably 1 or less, and most preferably is 0.8 or less.

It is defined that NA1 represents the image side numerical aperture of the objective lens, necessary for reproducing and/or recording information for the first optical disc, NA2 (NA1≧NA2) represents that the image side numerical aperture of the objective lens necessary for reproducing and/or recording for the information to the second optical disc, and NA3 (NA2>NA3) represents that the image side numerical aperture of the objective lens necessary for reproducing and/or recording information for the third optical disc. It is preferable that NA1 is one of: 0.8 or more, and 0.9 or less; and 0.55 or more, and 0.7 or less. Specifically, preferable NA1 is 0.85. It is preferable that NA2 is 0.55 or more, and is 0.7 or less. Specifically, preferable NA2 is 0.60. Further, it is preferable that NA3 is 0.4 or more, and is 0.55 or less. Specifically, preferable NA3 is 0.45 or 0.53.

It is preferable that the border of the central area and the peripheral area in the objective lens is formed in a portion corresponding to the range being 0.9·NA3 or more and being 1.2·NA3 or less (more preferably, 0.95·NA3 or more, and 1.15·NA3 or less), when the third light flux is used. More preferably, the border of the central area and the peripheral area of the objective lens is formed in a portion corresponding to NA3. Further, it is preferable that the border of the peripheral area and the most peripheral area of the objective lens is formed in a portion corresponding to the range being 0.9·NA2 or more, and being 1.2·NA2 or less (more preferably, being 0.95·NA2 or more, and being 1.15·NA2 or less), when the second light flux is used. More preferably, the border of the peripheral area and the most peripheral area of the objective lens is formed in a portion corresponding to NA2. It is preferable that the border of the outside of the most peripheral area of the objective lens is formed in a portion corresponding to the range being than 0.9·NA1 or more, and being 1.2·NA1 or less (more preferably, being 0.95·NA1 or more, and being 1.15·NA1 or less), when the first light flux is used. More preferably, the border of the outside of the most peripheral area of the objective lens is formed in a portion corresponding to NA1.

When the third light flux passing through the objective lens is converged on the information recording surface of the third optical disc, it is preferable that the spherical aberration has at least one discontinuous portion. In that case, it is preferable that the discontinuous portion exists in the range being 0.9·NA3 or more, and being 1.2·NA3 or less (more preferably, being 0.95·NA3 or more, and being 1.15·NA3 or less), when the third light flux is used. Further, also when the second light flux passing through the objective lens is converged on the information recording surface of the second optical disc, it is preferable that the spherical aberration has at least one discontinuous portion. In that case, it is preferable that the discontinuous portion exists in the range being 0.9·NA2 or more, and being 1.2·NA2 or less (more preferably, being 0.95·NA2 or more, and being 1.1·NA2 or less), when the second light flux is used.

Further, when the spherical aberration is continuous and does not have the discontinuous portion, and when the third light flux passing through the objective lens is converged on the information recording surface of the third optical disc, it is preferable that the absolute value of the longitudinal spherical aberration is 0.03 μm or more in NA2, and the absolute value of the longitudinal spherical aberration is 0.02 μm or less in NA3. More preferably, the absolute value of the longitudinal spherical aberration is 0.08 μm or more in NA2, and the absolute value of the longitudinal spherical aberration is 0.01 μm or less in NA3. Further, when the second light flux passing through the objective lens is converged on the information recording surface of the second optical disc, it is preferable that the absolute value of the longitudinal spherical aberration is 0.03 μm or more in NA1, and the absolute value of the longitudinal spherical aberration is 0.005 μm or less in NA2.

An optical disc drive device including the above optical pickup apparatus can be incorporated in an optical information recording and reproducing apparatus.

Herein, the optical disc drive apparatus installed in the optical information recording and reproducing apparatus will be described. There is provided the optical disc drive apparatus employing a system such that there is a tray which can hold an optical disc with the optical disc placed thereon and only the tray is taken out from the main body of the optical information recording and reproducing apparatus which houses an optical pickup apparatus therein; and a system such that the main body of the optical disc drive apparatus which houses an optical pickup apparatus therein is taken out.

The optical information recording and reproducing apparatus using each of the above described systems, is generally provided with the following component members: an optical pickup apparatus housed in a housing; a drive source of the optical pickup apparatus such as a seek-motor by which the optical pickup apparatus is moved together with the housing toward the inner periphery or outer periphery of the optical disc; traveling means for the optical pickup apparatus, including a guide rail for guiding the housing of the optical pickup apparatus toward the inner periphery or outer periphery of the optical disc; and a spindle motor for rotation drive of the optical disc. However, the component members of the optical information recording and reproducing apparatus are not limited to those.

The optical information recording and reproducing apparatus employing the former system is preferably provided with, other than those component members, a tray which can hold an optical disc under the condition that the optical disc is placed thereon, and a loading mechanism for slidably moving the tray. It is preferable that the optical information recording and reproducing apparatus employing the latter system does not include the tray and loading mechanism, and respective component members are provided in a drawer corresponding to chassis which can be taken out outside.

### ADVANTAGEOUS EFFECTS OF INVENTION

According to the present invention, information recording and/or reproducing for different three types of optical discs (for example, high density optical disc for which a blue-violet laser light source is used, and optical discs of DVD and CD) can be carried out compatibly by one optical pickup apparatus in spite of its simple and inexpensive structure. Further, there can be provided an optical pickup apparatus and objective lens capable of information recording and/or reproducing properly for each of the different three types of optical discs by using an objective lens formed of a single plastic lens.

### BRIEF DESCRIPTION OF THE DRAWINGS

FIG. 1 is a schematic diagram showing a structure of an optical pickup apparatus relating to the present invention.

FIG. 2 is a cross sectional view of an objective lens.

FIG. 3 is a diagram for illustrating the principal to correct a deterioration in aberration caused by a temperature change, with an optical path difference providing structure.

FIG. 4 is a longitudinal spherical aberration diagram of an objective lens relating the present example when the objective lens works for BD.

FIG. 5 is a longitudinal spherical aberration diagram of an objective lens relating the present example when the objective lens works for DVD.

FIG. 6 is a longitudinal spherical aberration diagram of an objective lens relating the present example when the objective lens works for CD.

### REFERENCE SIGNS LIST

AC two-axis actuator
PPS Dichroic prism
CL Collimation lens
LD1 Blue-violet semiconductor laser
LM Laser module
OBJ Objective lens
PL1 Protective substrate
PL2 Protective substrate
PL3 Protective substrate
PU1 Optical pickup apparatus
RL1 Information recording surface
RL2 Information recording surface
RL3 Information recording surface

### BEST MODE FOR CARRYING OUT THE INVENTION

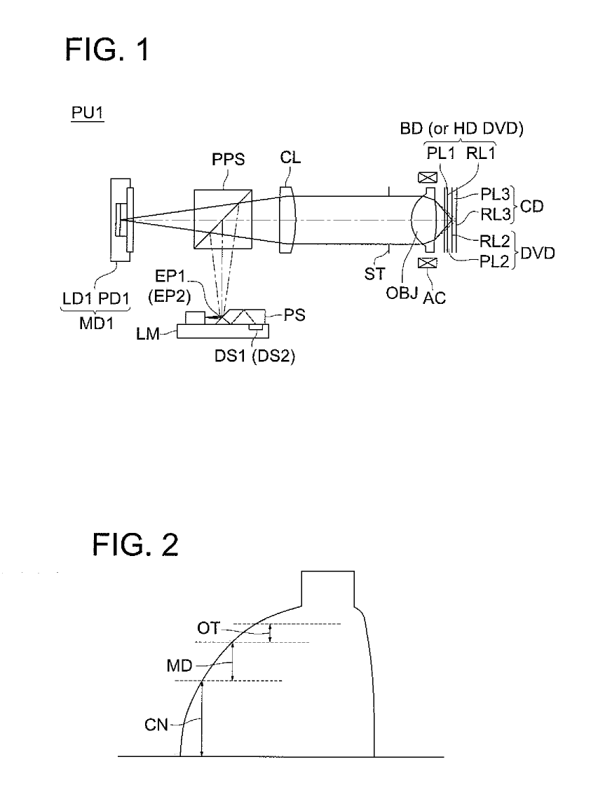

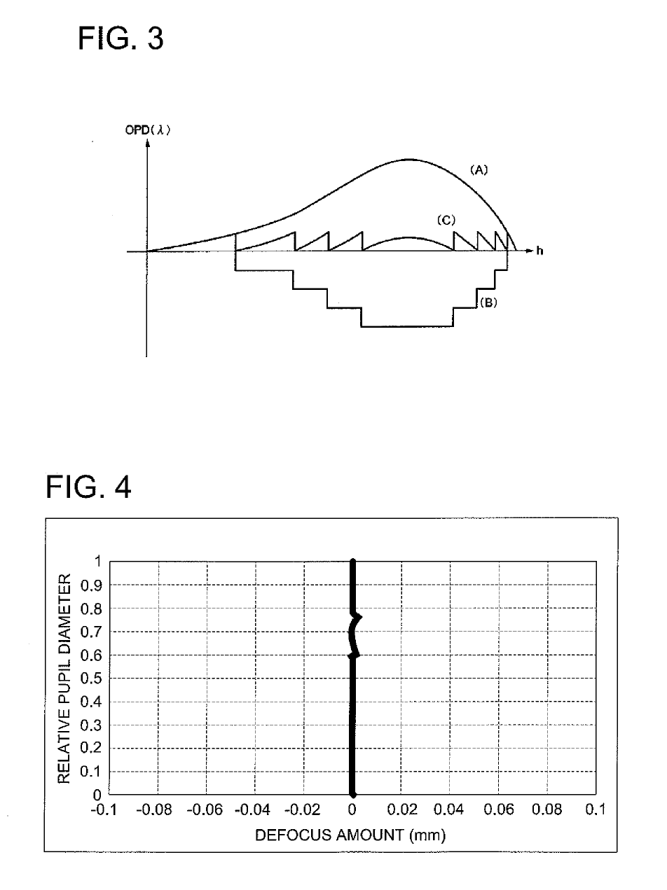

Preferred embodiments of the present invention will be described below. FIG. 1 is a diagram schematically showing optical pickup apparatus PU1 of the present embodiment capable of recording and/or reproducing information adequately for BD, DVD and CD which are different optical discs. The optical pickup apparatus PU1 can be mounted in the optical information recording and reproducing apparatus. Herein, the first optical disc is BD, the second optical disc is DVD, and the third optical disc is CD. Hereupon, the present invention is not limited to the present embodiment.

Optical pickup apparatus PU1 comprises objective lens OBJ; stop ST; collimation lens CL; dichroic prism PPS; first semiconductor laser LD1 (the first light source) which emits a laser light flux with a wavelength of 405 nm (the firs light flux) when information is recorded/reproduced for ED; and first light-receiving element PD1 which receives a reflection light flux from information recording surface RL1 of BD; and laser module LM.

Further, the laser module LM comprises second semiconductor laser EP1 (the second light source) which emits a laser light flux with a wavelength of 658 nm (the second light flux) when information is recorded and/or reproduced for DVD; third semiconductor laser EP2 (the third light source) emitting a laser light flux with a wavelength of 785 nm (the third light flux) when information is recorded and/or reproduced for CD; second light-receiving element DS1 which receives a reflection light flux from information recording surface RL2 of DVD; the third light receiving element DS2 which receives a reflection light flux from information recording surface RL3 of CD; and a prism PS.

Objective lens OBJ of the present embodiment is a single lens made of polyolefin plastic. As shown in FIG. 2, objective lens OBJ can be divided into central area CN including the optical axis; peripheral area MD arranged around the central area; and most peripheral area OT further arranged around the peripheral area, which correspond to types of light fluxes passing through the objective lens. In the central area on the optical surface facing light sources (which may a surface facing optical discs, alternatively), a first optical path difference providing structure and a third optical path difference providing structure are formed with being overlapped with each other. It is defined that M is a diffraction order of a diffracted light flux with the maximum diffracted light amount among diffracted light fluxes generated when the first light flux with wavelength λ1 emitted from blue-violet semiconductor laser LD1 enters the first optical path difference providing structure, N is a diffraction order of a diffracted light flux with the maximum diffracted light amount among diffracted light fluxes generated when the second light flux with wavelength λ2 emitted from laser module LM enters the first optical path difference providing structure, and M is a diffraction order of a diffracted light flux with the maximum diffracted light amount among diffracted light fluxes generated when the third light flux with wavelength λ3 emitted from laser module LM enters the first optical path difference providing structure. Under the definitions, (M, N, O)=(+1, −1, −2) is satisfied. It is defined that R is a diffraction order of a diffracted light flux with the maximum diffracted light amount among diffracted light fluxes generated when the first light flux with wavelength λ1 enters the third optical path difference providing structure, S is a diffraction order of a diffracted light flux with the maximum diffracted light amount among diffracted light fluxes generated when the second light flux with wavelength λ2 enters the third optical path difference providing structure, and diffraction order T is a diffraction order of a diffracted light flux with the maximum diffracted light amount among diffracted light fluxes generated when the third light flux with wavelength λ3 enters the third optical path difference providing structure. Under the definitions, (R, S, T)=(+10, +6, +5) is satisfied.

In the peripheral area, a second optical path difference providing structure and a fourth optical path difference providing structure are formed with being overlapped with each other. It is defined that P is a diffraction order of a diffracted light flux with the maximum diffracted light amount among diffracted light fluxes generated when the first light flux with wavelength λ1 enters the second optical path difference providing structure, and Q is a diffraction order of a diffracted light flux with the maximum diffracted light amount among diffracted light fluxes generated when the second light flux with wavelength λ2 enters the second optical path difference providing structure. Under the definitions, (P, Q)=(+1, −1) is satisfied. It is defined that V is a diffraction order of a diffracted light flux with the maximum diffracted light amount among diffracted light fluxes generated when the first light flux with wavelength λ1 enters the fourth optical path difference providing structure, and W is a diffraction order of a diffracted light flux with the maximum diffracted light amount among diffracted light fluxes generated when the second light flux with wavelength λ2 enters the fourth optical path difference providing structure. Under the definitions, (V, W)=(+10, +6) is satisfied. Further in the peripheral area, an optical path difference providing structure for making the third light flux flare is overlapped with the second optical path difference providing structure and the fourth optical path difference providing structure. It is defined that 0th diffraction order is a diffraction order of a diffracted light flux with the maximum diffracted light amount among diffracted light fluxes generated when the first light flux with wavelength λ1 emitted from blue-violet semiconductor laser LD1 enters the optical path difference providing structure for making the third light flux flare, 0th diffraction order is a diffraction order of a diffracted light flux with the maximum diffracted light amount among diffracted light fluxes generated when the second light flux with wavelength λ2 emitted from laser module LM enters the optical path difference providing structure for making the third light flux flare, and ±1st diffraction order is a diffraction order of a diffracted light flux with the maximum diffracted light amount among diffracted light fluxes generated when the third light flux with wavelength λ3 emitted from laser module LM enters the optical path difference providing structure for making the third light flux flare.

Blue-violet semiconductor laser LD1 emits a first light flux (λ1=405 nm) which is a divergent light flux. The divergent light flux passes through dichroic prism PPS, and is converted into a collimated light flux by collimation lens CL. The diameter of the collimated light flux is regulated by stop ST, and objective lens OBJ forms the regulated light flux into a spot on information recording surface RL1 of BD through the protective substrate with thickness of 0.0875 mm.

The light flux on information recording surface RL1 is reflected and modulated by the information pit on the information recording surface RL1. The reflected light flux passes through objective lens OBJ, stop ST again, and collimation lens CL converts the light flux into a convergent light flux. The convergent light flux passes through dichroic prism PPS and is converged on a light-receiving surface of the first light receiving element PD1. Then, information recorded in BD can be read based on the output signal of the first light-receiving element PD1, by performing focusing and tracking operations for objective lens OBJ using biaxial actuator AC.

Red semiconductor laser EP1 emits a second light flux (λ2=658 nm) which is a divergent light flux. The divergent light flux is reflected by the prism PS and is further reflected by dichroic prism PPS. Collimation lens CL collimate the reflected light flux into a finite divergent light flux, then the light flux enters objective lens OBJ. Herein, the incident light flux is converged by the central area and the peripheral area of the objective lens OBJ (the light flux passing through the most peripheral area is made into flare, and forms the peripheral spot portion). The converged light flux becomes a spot on information recording surface RL2 of DVD through the protective substrate PL2 with a thickness of 0.6 mm, and forms the central spot portion.

The light flux on information recording surface RL2 is reflected and modulated by the information pit on the information recording surface RL2. The reflection light flux passes through objective optical lens OBJ and stop ST again, and collimation lens CL converts the light flux into a convergent light flux. The convergent light flux is reflected by the dichroic prism PPS, then, is reflected two times in the prism, and converged on the second light-receiving element DS1. Then, the information recorded in DVD can be read by using the output signal of the second light receiving element DS1.

Infrared semiconductor laser EP2 emits the third light flux (λ3=785 nm) which is a divergent light flux. The divergent light flux is reflected by prism PS, and further reflected by dichroic prism PPS. Collimation lens CL converts the reflected light flux into a finite divergent light flux and the resulting light flux enters into objective lens OBJ. Herein, the light flux converged by the central area of the objective lens OBJ becomes a spot on information recording surface RL3 of CD through the protective substrate PL3 with thickness of 1.2 mm. The light flux to travel the outside of the central area is shielded with a dichroic filter (which is not illustrated) arranged at the front of objective lens OBJ, and does not enter the peripheral area and the most peripheral area of objective lens OBJ.

The light flux on information recording surface RL3 is reflected and modulated by the information pit on the information recording surface RL3. The reflection light flux passes through objective lens OBJ and stop ST again. Collimation lens CL converts the light flux into a convergent light flux, the convergent light flux is reflected by the dichroic prism PPS, then, is further reflected two times in the prism. The reflected light flux is converged on the third light-receiving element DS2. Then, information recorded in CD can be read by using output signal of the third light-receiving element DS2.

### EXAMPLES

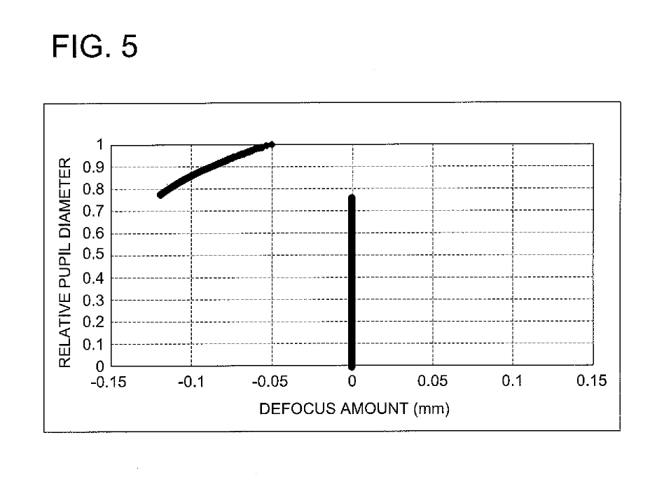

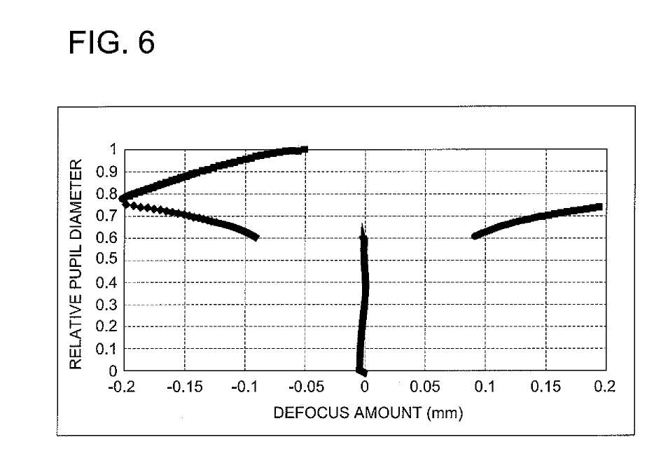

Next, an example which can be used for the above described embodiment will be described. Table 1 shows lens data of the present example. With respect to the objective lens relating to the present example, FIG. 4 shows a longitudinal spherical aberration when the objective lens works for BD, FIG. 5 shows a longitudinal spherical aberration when the objective lens works for DVD, and FIG. 6 shows a longitudinal spherical aberration when the objective lens works for CD. Hereinafter (including lens data in a table), the power of 10 will be expressed as by using “E” (For example, 2.5×10⁻³ will be expressed as 2.5E-3).

TABLE 1

| | | | |
|---|---|---|---|
| Focal length of | f₁ = 2.20 mm | f₂ = 2.38 mm | f₃ = 2.51 mm |
| objective lens | | | |
| Numerical aperture | NA1: 0.85 | NA2: 0.60 | NA3: 0.45 |
| Multiple | m1: 0 | m2: −1/104.2 | m3: −1/79.4 |

| i^{th} | | di | ni | di | ni | di | ni |
|---|---|---|---|---|---|---|---|
| surface | ri | (405 nm) | (405 nm) | (658 nm) | (658 nm) | (783 nm) | (783 nm) |
| 0 | ∞ | ∞ | | 250.00 | | 200.00 | |
| 1 (Stop | ∞ | 0.0 | | 0.0 (φ mm) | | 0.0 (φ mm) | |
| diameter) | | (φ3.74 mm) | | | | | |
| 2-1 | 1.4858 | 2.680 | 1.560 | 2.680 | 1.541 | 2.680 | 1.537 |
| 2-2 | 1.4767 | | | | | | |
| 2-3 | 1.4812 | | | | | | |
| 3 | −2.9923 | | | | | | |
| 4 | ∞ | 0.66 | | 0.58 | | 0.38 | |
| 5 | ∞ | 0.0875 | 1.620 | 0.600 | 1.577 | 1.200 | 1.571 |

| | | Surface No. | | | |
|---|---|---|---|---|---|
| | | 2-1 | 2-2 | 2-3 | 3 |
| Area | | h ≦ 1.125 | 1.125 < h ≦ 1.434 | 1.434 ≦ h | |
| Aspheric surface | κ | −5.4532E−01 | −6.3479E−01 | −6.5253E−01 | −8.1479E+01 |
| coefficient | A0 | 0.0000E+00 | 1.3926E−03 | −2.0894E−03 | 0.0000E+00 |
| | A4 | 7.6088E−03 | 7.8824E−03 | 7.0296E−03 | 9.8353E−02 |
| | A6 | 1.0954E−03 | −9.5829E−04 | −1.3234E−03 | −9.6971E−02 |
| | A8 | 1.7623E−03 | 2.6999E−03 | 2.8306E−03 | 7.2604E−02 |
| | A10 | −3.0315E−03 | −1.7450E−03 | −1.4809E−03 | −4.3325E−02 |
| | A12 | 5.5123E−04 | 1.0535E−05 | 2.3172E−04 | 1.4533E−02 |
| | A14 | 5.7363E−04 | 3.3591E−04 | 2.3452E−04 | −1.7876E−03 |
| | A16 | −8.6634E−04 | −1.6407E−04 | −1.6796E−04 | −7.4777E−05 |
| | A18 | 4.4934E−05 | 3.5566E−05 | 4.4940E−05 | 0.0000E+00 |
| | A20 | 1.2493E−04 | −3.4405E−06 | −4.4905E−06 | 0.0000E+00 |
| Optical path | Diffraction order | 1/−1/−2 | 1/−1/−2 | | |
| difference function | Manufacturing wavelength | 405 | 405 | | |
| of the optical path | B2 | −6.0762E−03 | −5.7524E−04 | | |
| difference providing | B4 | 7.7813E−04 | −4.6103E−04 | | |
| structure for | B6 | −9.0212E−04 | 8.0206E−04 | | |
| compatibility | B8 | 5.6861E−04 | −4.6714E−04 | | |
| | B10 | −1.4669E−04 | 9.2802E−05 | | |
| Optical path | Diffraction order | 10/6/5 | 10/6/5 | 5/3/2 | |
| difference function | Manufacturing wavelenth | 405 | 405 | 405 | |
| of the structure for | B2 | −2.5270E−04 | −8.5020E−05 | −1.8848E−03 | |
| correcting | B4 | 5.3925E−05 | −7.4254E−05 | −3.7091E−04 | |
| temperature | B6 | 3.8111E−05 | −4.5084E−05 | 1.2596E−04 | |
| characteristic | B8 | 8.2687E−05 | −2.2108E−05 | −8.7211E−05 | |
| | B10 | −1.4196E−04 | −9.3509E−06 | 6.4853E−06 | |
| Optical path | Diffraction order | | 0/0/1 | | |
| difference function | Manufacturing wavelength | | 785 | | |
| of the structure for | B2 | | 5.0000E−03 | | |
| generating flare | B4 | | 0.0000E+00 | | |
| | B6 | | 0.0000E+00 | | |
| | B8 | | 0.0000E+00 | | |
| | B10 | | 2.0000E−04 | | |

Each optical surface of the objective lens is formed as an aspheric surface, which has a symmetric shape around the optical axis defined by a mathematical expression obtained by assigning the coefficients shown in Table 1 to Math 1.

$$X ( h ) = \frac{( {h}^{2} / r )}{1 + \overline{) 1 - ( 1 + κ ) {( h / r )}^{2}}} + {\sum }_{i = 0}^{10} {A}_{2 i} {h}^{2 i} \qquad [ Math 1 ]$$

Herein, X(h) is an axis along the optical axis (the direction of traveling light is defined as a positive direction), κ is a conic constant, A₂ᵢ is an aspheric coefficient, h is a height from the optical axis.

Further, the optical path difference providing structure provides an optical path length for light fluxes of respective wavelengths, and the optical path length is defined by a mathematical expression obtained by assigning the coefficients shown in Table 1 to Math 2.

$$Φ ( h ) = λ / {λ}_{B} \times dor \times {\sum }_{i = 0}^{5} {B}_{2 i} {h}^{2 i} \qquad [ Math 2 ]$$

In the expression, λ is a wavelength of an incident light flux, λ_{B} is a manufacturing wavelength (blaze wavelength), dor is a diffraction order, B₂ᵢ is a coefficient of the optical path difference function.

According to the present embodiment, information can be stably recorded and reproduced for optical discs even in case of temperature change.

1. An objective lens for use in an optical pickup apparatus, and for forming a converged spot on an information recording surface of a first optical disc including a protective layer with a thickness t1 by using a first light flux with a wavelength λ1 emitted from a first light source, forming a converged spot on an information recording surface of a second optical disc including a protective layer with a thickness t2 (t1≦t2) by using a second light flux with a wavelength λ2 (λ1<λ2) emitted from a second light source, and forming a converged spot on an information recording surface of a third optical disc including a protective layer with a thickness t3 (t2<t3) by using a third light flux with a wavelength λ3 (λ2<λ3), the objective lens comprising:
an optical surface which at least includes a central area including an optical axis, a peripheral area formed in a ring shape around the central area, and a most peripheral area formed in a ring shape around the peripheral area,
wherein the objective lens is a single lens formed of plastic,
the objective lens converges the first light flux passing through the central area, the peripheral area, and the most peripheral area onto the information recording surface of the first optical disc,
the objective lens converges the second light flux passing through the central area and the peripheral area onto the information recording surface of the second optical disc,
the objective lens converges the third light flux passing through the central area onto the information recording surface of the third optical disc,
the central area includes a first optical path difference providing structure, and the objective lens satisfies any one of the following combinations:
(M, N, O)=(+1, −1, −2), (+1, −2, −3), and (+1, −1, −1),
where M is a diffraction order of a diffracted light flux with a maximum diffracted light amount among diffracted light fluxes generated when the first light flux enters the first optical path difference providing structure, N is a diffraction order of a diffracted light flux with a maximum diffracted light amount among diffracted light fluxes generated when the second light flux enters the first optical path difference providing structure, and O is a diffraction order of a diffracted light flux with a maximum diffracted light amount among diffracted light fluxes generated when the third light flux enters the first optical path difference providing structure,
the peripheral area includes a second optical path difference providing structure, and
the objective lens further comprises an optical path difference providing structure for correcting a temperature characteristic, where the optical path difference providing structure corrects an aberration caused by a temperature change of the objective lens.

2. The objective lens of claim 1,
wherein the objective lens satisfies P≠Q, where P is a diffraction order of a diffracted light flux with a maximum diffracted light amount among diffracted light fluxes generated when the first light flux enters the second optical path difference providing structure, and Q is a diffraction order of a diffracted light flux with a maximum diffracted light amount among diffracted light fluxes generated when the second light flux enters the second optical path difference providing structure.

3. The objective lens of claim 1,
wherein the optical path difference providing structure for correcting a temperature characteristic, is a third optical path difference providing structure formed to be overlapped with the first optical path difference providing structure in the central area, or a fourth optical path difference providing structure formed to be overlapped with the second optical path difference providing structure in the peripheral area.

4. The objective lens of claim 3,
wherein the objective lens satisfies R=+10, S=+6, and T=+5, where R is a diffraction order of a diffracted light flux with a maximum diffracted light amount among diffracted light fluxes generated when the first light flux enters the third optical path difference providing structure, S is a diffraction order of a diffracted light flux with a maximum diffracted light amount among diffracted light fluxes generated when the second light flux enters the third optical path difference providing structure, and T is a diffraction order of a diffracted light flux with a maximum diffracted light amount among diffracted light fluxes generated when the third light flux enters the third optical path difference providing structure.

5. The objective lens of claim 3,
wherein the objective lens satisfies R=+2, S=+1, and T=+1, where R is a diffraction order of a diffracted light flux with a maximum diffracted light amount among diffracted light fluxes generated when the first light flux enters the third optical path difference providing structure, S is a diffraction order of a diffracted light flux with a maximum diffracted light amount among diffracted light fluxes generated when the second light flux enters the third optical path difference providing structure, and T is a diffraction order of a diffracted light flux with a maximum diffracted light amount among diffracted light fluxes generated when the third light flux enters the third optical path difference providing structure.

6. The objective lens of claim 3,
wherein the objective lens satisfies V=+10 and W=+6, where V is a diffraction order of a diffracted light flux with a maximum diffracted light amount among diffracted light fluxes generated when the first light flux enters the fourth optical path difference providing structure, and W is a diffraction order of a diffracted light flux with a maximum diffracted light amount among diffracted light fluxes generated when the second light flux enters the fourth optical path difference providing structure.

7. The objective lens of claim 3,
wherein the objective lens satisfies V=+5 and W=+3, where V is a diffraction order of a diffracted light flux with a maximum diffracted light amount among diffracted light fluxes generated when the first light flux enters the fourth optical path difference providing structure, and W is a diffraction order of a diffracted light flux with a maximum diffracted light amount among diffracted light fluxes generated when the second light flux enters the fourth optical path difference providing structure.

8. The objective lens of claim 3,
wherein the objective lens satisfies V=+2 and W=+1, where V is a diffraction order of a diffracted light flux with a maximum diffracted light amount among diffracted light fluxes generated when the first light flux enters the fourth optical path difference providing structure, and W is a diffraction order of a diffracted light flux with a maximum diffracted light amount among diffracted light fluxes generated when the second light flux enters the fourth optical path difference providing structure.

9. The objective lens of claim 1, further comprising a fifth optical path difference providing structure as an optical path difference providing structure for correcting a temperature characteristic arranged in the most peripheral area formed around the peripheral area,
wherein the objective lens converges the first light flux passing through the most peripheral area onto the information recording surface of the first optical disc.

10. The objective lens of claim 1,
wherein the optical path difference providing structure for correcting a temperature characteristic, is a fifth optical path difference providing structure formed in the most peripheral area.

11. An optical pickup apparatus comprising an objective lens of claim 1.
